(19) United States
(12) Patent Application Publication
(10) Pub. No.: US 2024/0155637 A1
(43) Pub. Date: May 9, 2024

(54) DCI FORMAT CONFIGURED FOR VARIED BIT INTERPRETATIONS

(71) Applicant: Intel Corporation, Santa Clara, CA (US)

(72) Inventors: Guotong Wang, Beijing (CN); Alexei Davydov, Nizhny Novgorod (RU); Victor Sergeev, Nizhny Novgorod (RU); Avik Sengupta, San Jose, CA (US)

(21) Appl. No.: 18/280,525

(22) PCT Filed: Apr. 5, 2022
(86) PCT No.: PCT/US2022/023462

§ 371 Date: Sep. 6, 2023

(30) Foreign Application Priority Data
Apr. 6, 2021 (WO) PCT/CN2021/085540
Apr. 6, 2021 (WO) PCT/CN2021/085554
Apr. 6, 2021 (WO) PCT/CN2021085556

(51) Int. Cl. H04W 72/232; H04L 5/00; H04W 72/12

(52) U.S. Cl. CPC H04W 72/232; H04L 5/0057; H04L 5/0094; H04W 72/12

(57) ABSTRACT

A user equipment (UE) configured for operation in a fifth-generation (5G) new radio (NR) (5G-NR) system may decode a downlink control information (DCI) format comprising one of DCI format 0_1 and DCI format 0_2. When the DCI format does not schedule a physical uplink shared channel (PUSCH) and does not trigger a sounding reference signal (SRS) transmission, and when the DCI format at least triggers a channel state information (CSI) request including at least one of a CSI reference signal (CSI-RS) operation, a CSI interference measurement (CSI-IM), and a CSI report transmission, the UE may interpret one or more fields of the DCI format that would normally be used for PUSCH scheduling and/or SRS triggering as indicating additional information or parameters for the triggered CSI request. The UE may perform the triggered CSI request using at least the information in the one or more repurposed fields of the DCI.

This application claims priority to International Application No. PCT/CN2021/085540 filed Apr. 6, 2021, International Application No. PCT/CN2021/085556 filed Apr. 6, 2021, and International Application No. PCT/CN2021/085554 filed Apr. 6, 2021, which are incorporated herein by reference in their entireties.

### TECHNICAL FIELD

Embodiments pertain to wireless communications. Some embodiments relate to wireless networks including 3GPP (Third Generation Partnership Project) and fifth-generation (5G) networks including 5G new radio (NR) (or 5G-NR) networks. Some embodiments relate to sixth-generation (6G) networks.

### BACKGROUND

Mobile communications have evolved significantly from early voice systems to today's highly sophisticated integrated communication platform. With the increase in different types of devices communicating with various network devices, usage of 3GPP 5G NR systems has increased. The penetration of mobile devices (user equipment or UEs) in modern society has continued to drive demand for a wide variety of networked devices in many disparate environments. 5G NR wireless systems are forthcoming and are expected to enable even greater speed, connectivity, and usability, and are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

One issue with 5G NR systems is the lack of flexibility, such as the lack of flexibility for triggering sounding reference signal (SRS) transmissions and the lack of flexibility for indicating a DL or UL TCI state.

### BRIEF DESCRIPTION OF THE DRAWINGS

FIG. 1A illustrates an architecture of a network, in accordance with some embodiments.

FIG. 1B and FIG. 1C illustrate a non-roaming 5G system architecture in accordance with some embodiments.

FIG. 2A illustrates a radio resource control (RRC) configuration message for a sounding reference signal (SRS) resource set configuration, in accordance with some embodiments.

FIG. 2B illustrates an RRC configuration for a SRS resource, in accordance with some embodiments.

FIG. 3 illustrates un-used fields repurposed for beam indication by DCI 0_1/0_2 without PUSCH, without CSI Request and without SRS triggered, in accordance with some embodiments.

FIG. 4 illustrates un-used fields repurposed for beam indication by DCI 0_1/0_2 without PUSCH, without CSI Request and with SRS triggered, in accordance with some embodiments.

FIG. 5 illustrates different cases on re-using fields for DCI 0_1/0_2, in accordance with some embodiments.

FIG. 6. illustrates DCI indicated resource allocation for CSI-RS transmission, in accordance with some embodiments.

FIG. 7 illustrates DCI indicated slot offset for CSI-RS, in accordance with some embodiments.

FIG. 8 illustrates an example of indicated available slot for CSI-RS by DCI format 0_1/0_2 without scheduling UL-SCH and without triggering SRS, in accordance with some embodiments.

FIG. 9 illustrates repurposed unused fields for SRS triggered by DCI format 1_1/1_2 without scheduling PDSCH, in accordance with some embodiments.

FIG. 10 illustrates a CSI-RS triggered by DCI format 1_1/1_2 without scheduling PDSCH, in accordance with some embodiments.

FIG. 11 is a function block diagram of a wireless communication device, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In 5G NR, various downlink control information (DCI) formats are used for scheduling a physical uplink shared channel (PUSCH) transmission and scheduling a physical downlink shared channel (PDSCH) reception for a user equipment (UE). In some embodiments, various fields of DCI formats are repurposed to improve flexibility, such as flexibility for triggering sounding reference signal (SRS) transmissions and flexibility for indicating a DL or UL TCI state. These embodiments are discussed in more detail below.

In some embodiments, some un-used bits of DCI formats are repurposed for CSI-RS requests. In some embodiments, some un-used bits of DCI formats are repurposed for beam indication. These embodiments are described in more detail below.

Some embodiments are directed to a user equipment (UE) configured for operation in a fifth-generation (5G) new radio (NR) (5G-NR) system. In these embodiments, the UE may decode a downlink control information (DCI) format. The DCI format may comprise one of DCI format 0_1 and DCI format 0_2. In these embodiments, when the DCI format does not schedule a physical uplink shared channel (PUSCH) and does not trigger a sounding reference signal (SRS) transmission, and when the DCI format at least triggers a channel state information (CSI) request including at least one of a CSI reference signal (CSI-RS) operation, a CSI interference measurement (CSI-IM), and a CSI report transmission, the UE may interpret one or more fields of the DCI format that would normally be used for PUSCH scheduling and/or SRS triggering as indicating additional information or parameters for the triggered CSI request. The UE may perform the triggered CSI request using at least the information in the one or more re-purposed fields of the DCI. In these embodiments, some of the un-used DCI fields (i.e., fields that would be used for PUSCH scheduling and/or fields that are used for triggering the SRS transmission) may be re-purposed to reconfigure some CSI-RS/CSI-IM and/or CSI report parameters to facilitate the aperiodic CSI-RS/CSI-IM and/or aperiodic CSI report transmission, although the scope of the embodiments is not limited in this respect.

In some embodiments, the UE may be configured to decode the DCI format to determine that the DCI format does not schedule the PUSCH when an UL-SCH indicator of the DCI format is present (i.e., 1 bit) and is set to zero, determine that the DCI format does not trigger the SRS transmission when an SRS request field of the DCI format is set to all zeros, and determine that the DCI format triggers an CSI request when a CSI request field is set to a non-zero value, although the scope of the embodiments is not limited in this respect.

In some embodiments, the triggered CSI request may include at least one of an aperiodic CSI-RS operation, an CSI-IM and an aperiodic CSI report transmission. In some embodiments, the triggered CSI request may include a request for CSI-RS measurement, although the scope of the embodiments is not limited in this respect.

In some embodiments, the one or more repurposed fields of the DCI format that would normally be used for PUSCH scheduling and/or SRS triggering include one or more of a modulation and coding scheme (MCS) field, a Hybrid automatic repeat request (HARQ) field, a redundancy version field, a new data indicator field, and a transmit power control (TPC) command for PUSCH field. In these embodiments, the UE may interpret the one or more fields to configure or reconfigure a time domain and/or frequency domain resource allocation for the triggered CSI request, although the scope of the embodiments is not limited in this respect.

In some embodiments, the one or more fields to configure or reconfigure the resource allocation for the triggered CSI request comprise at least one of CSI-RS resource mapping, a bandwidth part (BWP) identifier (BWP-ID) indicating a BWP for reception of a CSI-RS, and power control offset information, although the scope of the embodiments is not limited in this respect.

In some embodiments, when the DCI format either schedules the PUSCH or the DCI format schedules the SRS transmission, the UE may be configured to interpret the one or more fields of the DCI format for the PUSCH scheduling and/or the SRS triggering, although the scope of the embodiments is not limited in this respect.

In some embodiments, when the DCI format does not schedule a PUSCH, does not trigger an SRS transmission, and does not trigger a CSI request, the UE may be configured to interpret one or more fields of the DCI format that would normally be used for PUSCH scheduling, SRS triggering, or the CSI request (e.g., an MCS field) for beam indication, although the scope of the embodiments is not limited in this respect.

In these embodiments, some of the un-used DCI fields (i.e., fields that are used for PUSCH scheduling, fields that are used for triggering the SRS transmission and/or filed that are used for the CSI request) may be re-purposed for beam indication, although the scope of the embodiments is not limited in this respect.

In some embodiments, when the UE is configured for multi-transmission-reception point (m-TRP) operation, and when the one or more fields are interpreted for beam indication, the one or more fields may be decoded as indicating first and second transmission control indication (TCI) states. The first TCI state may be associated with a first TRP and the second TCI state may be associated with a second TRP. In these embodiments, the UE may apply the first and second TCI states for reception of certain reference signals from the first and second TRPs, although the scope of the embodiments is not limited in this respect.

In these embodiments, a previously activated TCI state may be triggered by the DCI. In some embodiments, the TCI state may indicate a quasi co-located (QCL) type indicating whether antenna ports are QCL. Two antenna ports are said to be quasi co-located if properties of the channel over which a symbol on one antenna port is conveyed can be inferred from the channel over which a symbol on the other antenna port is conveyed, although the scope of the embodiments is not limited in this respect.

Some embodiments are directed to a non-transitory computer-readable storage medium that stores instructions for execution by processing circuitry of a user equipment (UE) configured for operation in a fifth-generation (5G) new radio (NR) (5G-NR) system. In these embodiments, the instructions may configure the processing circuitry to decode a downlink control information (DCI) format. The DCI format may comprise one of DCI format 0_1 and DCI format 0_2. In these embodiments, when the DCI format does not schedule a physical uplink shared channel (PUSCH) and does not trigger a sounding reference signal (SRS) transmission, and when the DCI format at least triggers a channel state information (CSI) request including at least one of a CSI reference signal (CSI-RS) operation, a CSI interference measurement (CSI-IM), and a CSI report transmission, the processing circuitry may be configured to interpret one or more fields of the DCI format that would normally be used for PUSCH scheduling and/or SRS triggering as indicating additional information or parameters for the triggered CSI request. In these embodiments, the UE may perform the triggered CSI request using at least the information in the one or more re-purposed fields of the DCI, although the scope of the embodiments is not limited in this respect.

Some embodiments are directed to a gNodeB (gNB) configured for operation in a fifth-generation (5G) new radio (NR) (5G-NR) system. In these embodiments, the gNB may encode a downlink control information (DCI) format for transmission to a user equipment (UE). The DCI format may comprise one of DCI format 0_1 and DCI format 0_2. In these embodiments, when the DCI format does not schedule a physical uplink shared channel (PUSCH) and does not trigger a sounding reference signal (SRS) transmission, and when the DCI format at least triggers a channel state information (CSI) request including at least one of a CSI reference signal (CSI-RS) operation, a CSI interference measurement (CSI-IM), and a CSI report transmission, the gNB may encode one or more fields of the DCI format that would normally be used for PUSCH scheduling and/or SRS triggering as indicating additional information or parameters for the triggered CSI request. In these embodiments, the one or more repurposed fields of the DCI format that would normally be used for PUSCH scheduling and/or SRS triggering may include one or more of a modulation and coding scheme (MCS) field, a Hybrid automatic repeat request (HARQ) field, a redundancy version field, a new data indicator field, and a transmit power control (TPC) command for PUSCH field. In these embodiments, the gNB may encode the one or more fields to configure or reconfigure a time domain and/or frequency domain resource allocation for the triggered CSI request, although the scope of the embodiments is not limited in this respect.

In some embodiments, the gNB may encode the DCI format to include an UL-SCH indicator in the DCI format and set the UL-SCH indicator to zero to indicate that the DCI format does not schedule the PUSCH. The gNB may also set an SRS request field to all zeros to indicate that the DCI format does not trigger the SRS transmission. The gNB may also set a CSI request field to a non-zero value to indicate that the DCI format triggers the CSI request, although the scope of the embodiments is not limited in this respect.

In these embodiments, the one or more fields may configure or reconfigure the resource allocation for the triggered CSI request may comprise at least one of CSI-RS resource mapping, a bandwidth part (BWP) identifier (BWP-ID) indicating a BWP for reception of a CSI-RS, and power control offset information, although the scope of the embodiments is not limited in this respect.

These embodiments are described in more detail below.

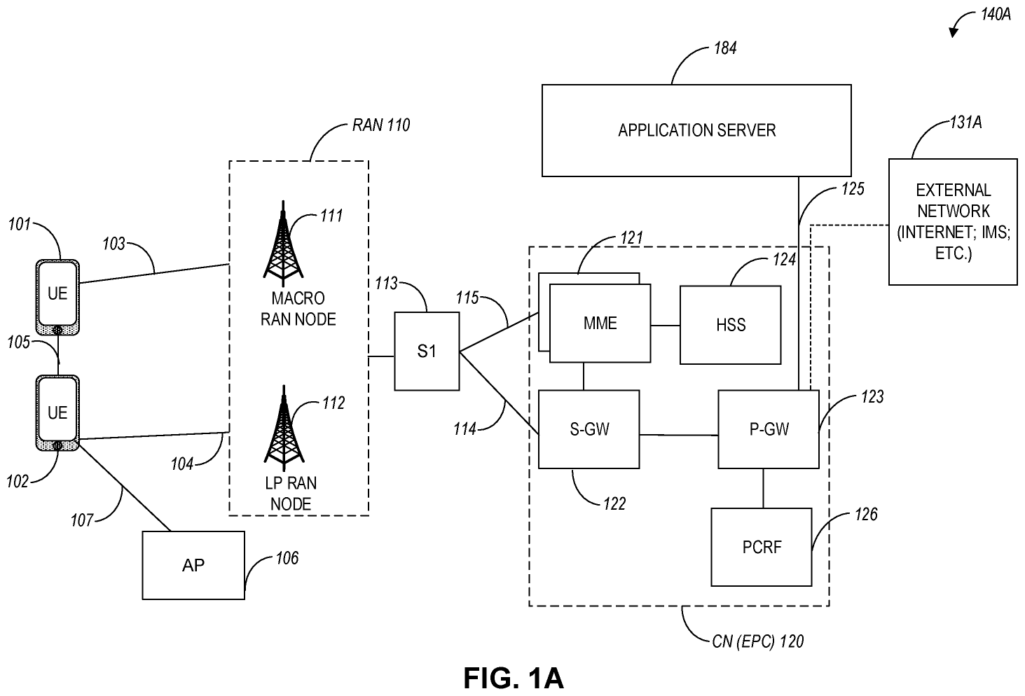

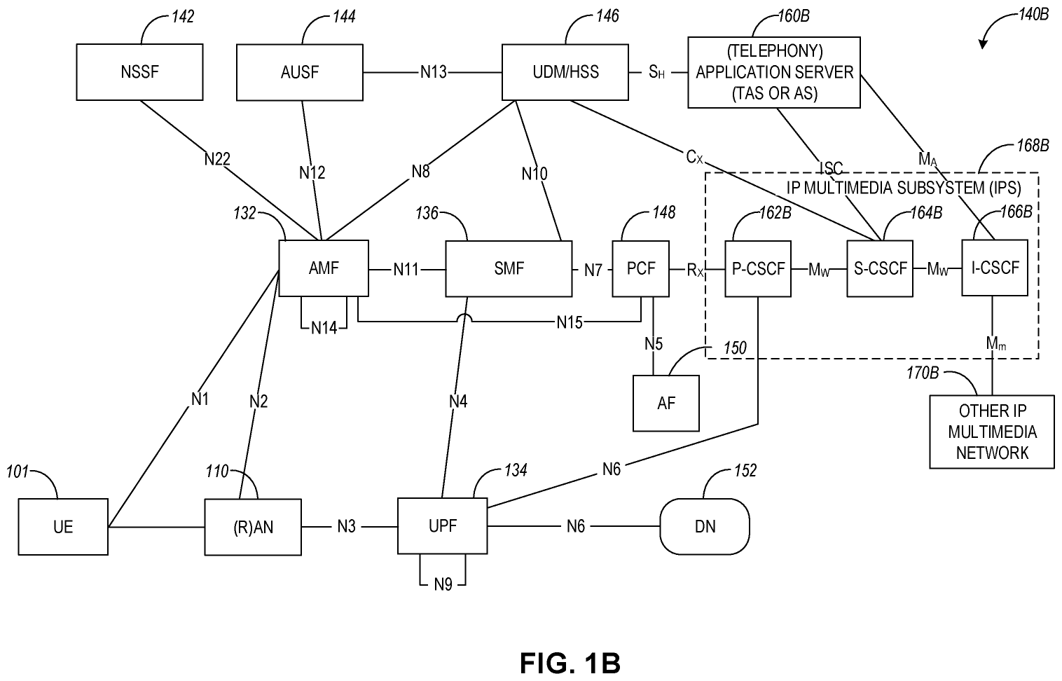

FIG. 1A illustrates an architecture of a network in accordance with some embodiments. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some embodiments, carrier aggregation may be used where one or more component carriers operate on unlicensed frequencies.

Embodiments described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Embodiments described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some embodiments, any of the UEs 101 and 102 can comprise an Internet-of-Things (IoT) UE or a Cellular IoT (CIoT) UE, which can comprise a network access layer designed for low-power IoT applications utilizing short-lived UE connections. In some embodiments, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some embodiments, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some embodiments, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro-RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In embodiments, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility embodiments in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some embodiments, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some embodiments, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some embodiments, the gNBs and the NG-eNBs can be connected to the AMF by NG-C interfaces, and to the UPF by NG-U interfaces. The gNBs and the NG-eNBs can be coupled to each other via Xn interfaces.

In some embodiments, the NG system architecture can use reference points between various nodes as provided by 3GPP Technical Specification (TS) 23.501 (e.g., V15.4.0, 2018-12). In some embodiments, each of the gNBs and the NG-eNBs can be implemented as a base station, a mobile edge server, a small cell, a home eNB, and so forth. In some embodiments, a gNB can be a master node (MN) and NG-eNB can be a secondary node (SN) in a 5G architecture.

FIG. 1B illustrates a non-roaming 5G system architecture in accordance with some embodiments. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some embodiments, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain embodiments of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some embodiments, the I-CSCF 166B can be connected to another IP multimedia network 170E, e.g. an IMS operated by a different network operator.

In some embodiments, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1, system architecture 140C can also include a network exposure function (NEF) 154 and a network repository function (NRF) 156. In some embodiments, 5G system architectures can be service-based and interaction between network functions can be represented by corresponding point-to-point reference points Ni or as service-based interfaces.

In some embodiments, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

In some embodiments, any of the UEs or base stations described in connection with FIGS. 1A-1C can be configured to perform the functionalities described herein.

Rel-15 NR systems are designed to operate on the licensed spectrum. The NR-unlicensed (NR-U), a short-hand notation of the NR-based access to unlicensed spectrum, is a technology that enables the operation of NR systems on the unlicensed spectrum.

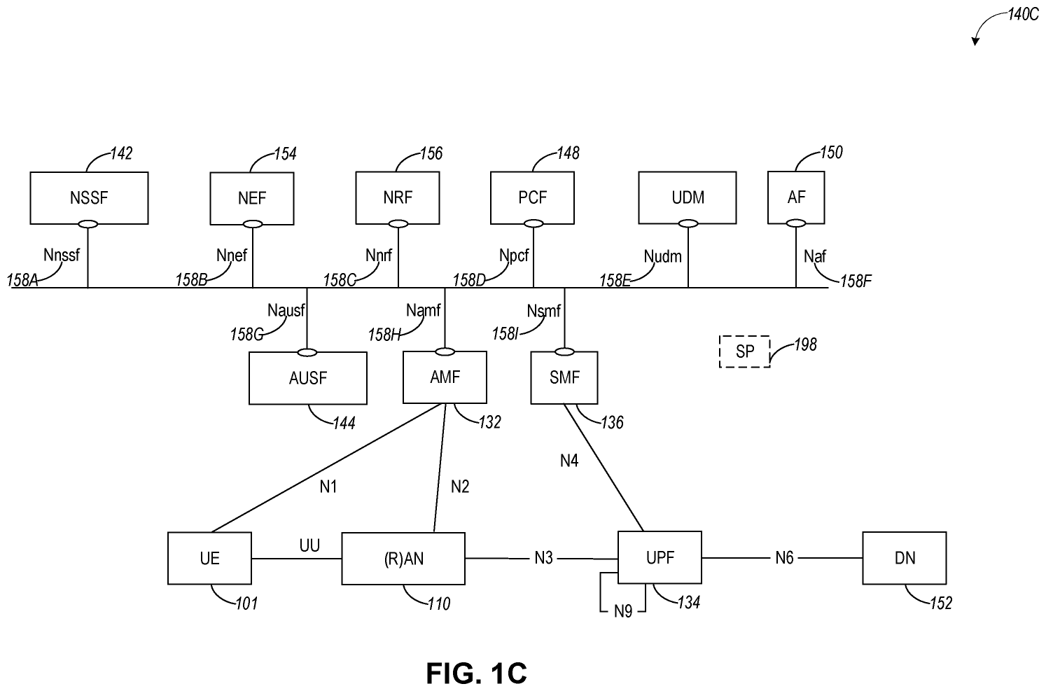

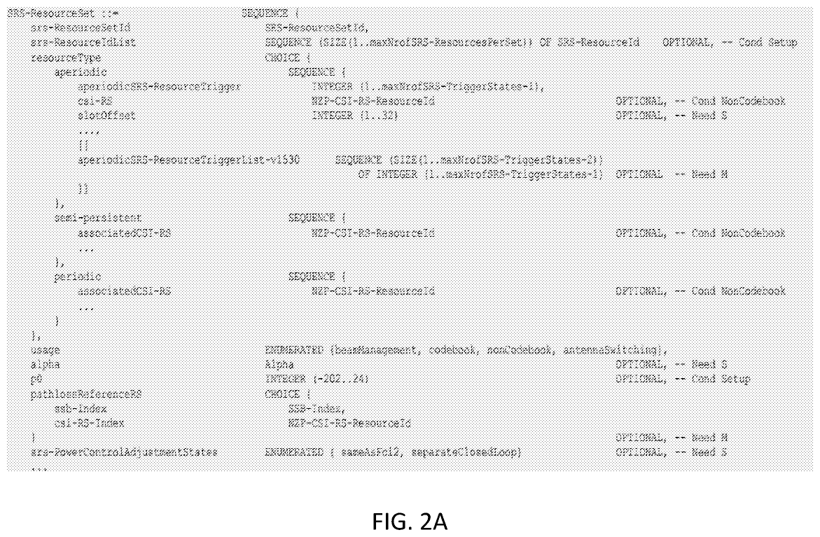

In the Rel-15 NR spec, different types of SRS resource sets are supported. The SRS resource set is configured with a parameter of ‘usage’, which can be set to ‘beamManagement’, ‘codebook’, ‘nonCodebook’ or ‘antennaSwitching’. The SRS resource set configured for ‘beamManagement’ is used for beam acquisition and uplink beam indication using SRS. The SRS resource set configured for ‘codebook’ and ‘nonCodebook’ is used to determine the UL precoding with explicit indication by TPMI (transmission precoding matrix index) or implicit indication by SRI (SRS resource index). Finally, the SRS resource set configured for ‘antennaSwitching’ is used to acquire DL channel state information (CSI) using SRS measurements in the UE by leveraging reciprocity of the channel in TDD systems. For SRS transmission, the time domain behavior could be periodic, semi-persistent or aperiodic. FIG. 2A and FIG. 2B show the RRC configuration for SRS resource set and SRS resource respectively.

When SRS resource set is configured as ‘aperiodic’, the SRS resource set also includes configuration of slot offset (slotOffset) and trigger state(s) (aperiodicSRS-ResourceTrigger, aperiodicSRS-ResourceTriggerList). The parameter of slotOffset defines the slot offset relative to PDCCH where SRS transmission should be commenced. The triggering state(s) defines which DCI codepoint(s) triggers the corresponding SRS resource set transmission.

The aperiodic SRS could be triggered via SRS Request field in DCI. SRS Request field could be carried by DCI format 0_1/0_2/1_1/1_2/2_3, wherein DCI format 0_1/0_2 is used for scheduling PUSCH, DCI format 1_1/1_2 is used for scheduling PDSCH and DCI format 2_3 is used to trigger aperiodic SRS for a group of UEs.

Table 1 shows the detailed fields and field length for DCI format 0_1 and 0_2 as defined by 3GPP TS 38.212 v16.4.0.

TABLE 1
Field length for DCI format 0_1 and 0_2

| Field | DCI format 0_1 | DCI format 0_2 |
|---|---|---|
| Identifier for DCI format | 1 | 1 |
| Carrier Indicator (CIF) | 0/3 | 0~3 |
| DFI flag | 0/1 | N/A |
| UL/SUL indicator | 0/1 | 0/2 |
| Bandwidth part (BWP) | 0~2 | 0~2 |
| indicator | | |
| Frequency domain | 0~18 | 0~18 |
| resource assignment | | |
| (FDRA) | | |
| Time domain resource | 0~6 | 0~6 |
| assignment (TDRA) | | |
| Frequency hopping (FH) | 0/1 | 0/1 |
| flag | | |
| Modulation and coding | 5 | 5 |
| scheme (MCS) | | |
| New data indicator | 1~8 | 1 |
| (NDI) | | |
| Redundancy version | 2~8 | 0~2 |
| (RV) | | |
| HARQ process number | 4 | 0~4 |
| 1^{st} downlink assignment | 1/2/4 | 0/1/2/4 |
| index (DAI) | | |
| 2^{nd} DAI | 0/2/4 | N/A |
| TPC command for | 2 | 2 |
| PUSCH | | |
| SRS resource indicator | 1~4 | 0~4 |
| (SRI) | | |
| Precoding information | 0~6 | 0~6 |
| and number of layers | | |
| Antenna ports | 2~5 | 0/2/3/4/5 |
| SRS request | 2/3 | 0~3 |
| CSI request | 0~6 | 0~6 |
| CBG transmission | 0/2/4/6/8 | N/A |
| information (CBGTI) | | |
| PTRS-DMRS | 0/2 | 0/2 |
| association | | |
| Beta-offset indicator | 0/2 | 0~2 |
| DMRS sequence | 0/1 | 0/1 |
| initialization | | |
| UL-SCH indicator | 0/1 | 0/1 |
| ChannelAccess-CPext- | 0~6 | N/A |
| CAPC | | |
| Open-loop power | 0/1/2 | 0/1/2 |
| control parameter set | | |
| indication | | |
| Priority indicator | 0/1 | 0/1 |
| Invalid symbol pattern | 0/1 | 0/1 |
| indicator | | |
| Minimum applicable | 0/1 | N/A |
| scheduling offset | | |
| indicator | | |
| SCell dormancy | 0~5 | N/A |
| indication | | |
| Sidelink assignment | 0/1/2 | N/A |
| index | | |

In order to improve flexibility for aperiodic SRS transmission, the SRS could be triggered via DCI without scheduling data, e.g. UL-SCH indicator field (1-bit) is set to ‘0’ and SRS Request field is set to non-zero.

In Rel-17, a common DL/UL TCI state could be configured to the UE, wherein the common TCI state (common beam) will be used for DL and UL transmission/reception. In Rel-17, separate DL/UL TCI state could be configured to the UE, wherein separate TCI state (separate beam) is used for DL and UL. If DCI format 0_1/0_2 is sent to the UE without scheduling PUSCH and without CSI Request, there are a lot of un-used bits. In this case, some bits can be re-used for beam indication, e.g. to indicate the DL/UL TCI state. The current DCI format 0_1/0_2 without scheduling PUSCH and without CSI Request doesn't consider beam indication.

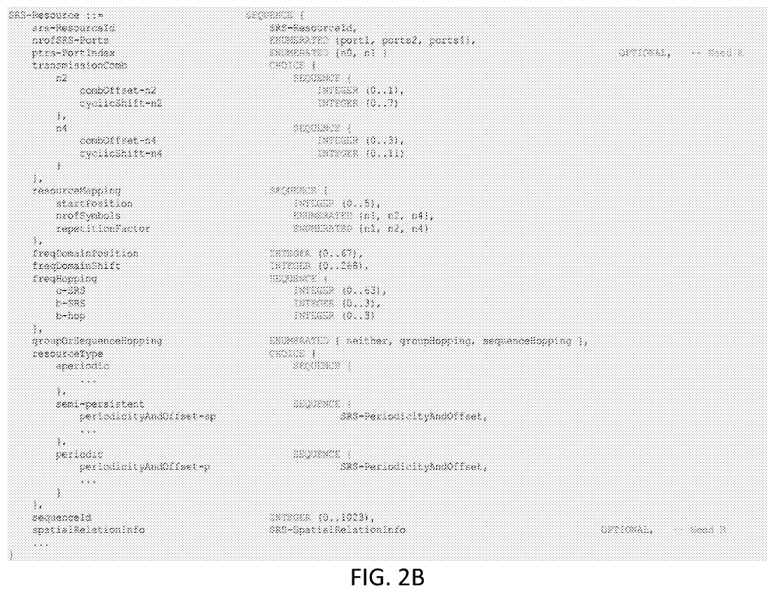

Various embodiments herein provide techniques to support beam indication via DCI format 0_1/0_2 without scheduling PUSCH, without CSI Request and with/without SRS triggered. FIG. 3 illustrates un-used fields repurposed for beam indication by DCI 0_1/0_2 without PUSCH, without CSI Request and without SRS triggered, in accordance with some embodiments.

Case A: TCI Indication Via DCI 0_1/0_2 without Scheduling PUSCH, without CSI Request and without SRS Triggered

In some embodiments, for DCI format 0_1/0_2, it is allowed that the field of UL-SCH indicator is present (1 bit) and set to ‘0’, CSI Request field is set to all zero(s), and SRS Request field is set to all zero(s). In this case, some un-used DCI fields could be repurposed for beam indication, for example, the MCS field, HARQ field, etc.

Some of the un-used bits could be used to indicate one or several or all of the following:
Common DL/UL TCI state, if common DL/UL TCI state is enabled.
Separate DL/UL TCI state, including DL TCI state and UL TCI state
DL TCI state only
UL TCI state only

In some embodiments, in the scenario of multi-TRP operation, two TCI states could be indicated via DCI format 0_1/0_2 without scheduling PUSCH, without CSI Request and without SRS triggered. Each TCI state is associated with different TRP. Or one codepoint of TCI state could indicate two beams, one for each TRP. There could be implicit or explicit association between the TCI state and TRP. For example, the 1^{st} TCI state corresponding to the 1^{st} TRP, and the 2^{nd} TCI state corresponds to the second TRP. Or there is explicit field(s) indicating which TRP is associated with the TCI state. In order to support dynamic switching between single TRP and multi-TRP operation, additional field(s) could be used to indicate whether the TCI state is present or not. Or a specific value for the TCI state field indicates the TCI state is not valid.

In some embodiments, in the scenario of carrier aggregation, multiple TCI states could be indicated via DCI format 0_1/0_2 without scheduling PUSCH, without CSI Request and without SRS triggered, one TCI state for each component carrier (CC). Or one TCI state is indicated and is applied to multiple CCs. Or one TCI state is indicated, and a bitmap is used to indicate which CC can apply the TCI state.

In some embodiments, if TCI state is indicated via DCI format 0_1/0_2 without scheduling PUSCH, without CSI Request and without SRS triggered, an SR-like over PUCCH could serve as acknowledgement (ACK) to the beam indication. The dedicated SR-like PUCCH resource could be configured to the UE. After receiving the beam indication, the UE could send the SR-like PUCCH for several times, e.g. N times, where N could be configurable or predefined. After the gNB receives the SR-like PUCCH, the gNB assumes the UE has received the beam indication DCI.

In some embodiments, after receiving the beam indication, the UE could send the SR-like PUCCH for several times, e.g. N times. After the gNB receives the SR-like PUCCH, the gNB should send another DCI with UL grant, e.g. PUSCH resource allocation. After the UE receives the UL grant, the UE knows the ACK to beam indication has been received by the gNB.

In some embodiments, if TCI state is indicated via DCI format 0_1/0_2 without scheduling PUSCH, without CSI Request and without SRS triggered, the UE should provide HARQ-ACK information in response to the beam indication DCI after N symbols from the last symbol of a PDCCH carrying the beam indication, wherein the value of N could be configurable or pre-defined.

Case B: TCI Indication Via DCI 0_1/0_2 without Scheduling PUSCH, without CSI Request and with SRS Triggered

In some embodiments, for DCI format 0_1/0_2 without scheduling PUSCH and without CSI Request, if aperiodic SRS is triggered, e.g. the SRS Request field is set to non-zero, some un-used DCI fields could be repurposed for beam indication, wherein the un-used DCI fields might be different as the un-used fields in Case A, e.g. DCI format 0_1/0_2 without scheduling PUSCH, without CSI Request and without SRS triggered. For example, in Case A (SRS is not triggered), MCS field is used for beam indication. When aperiodic SRS is triggered by DCI format 0_1/0_2 without scheduling PUSCH and without CSI Request, the MCS filed may be used to reconfigure some parameters for SRS. In this case, another un-used field, e.g. HARQ, may be used for beam indication.

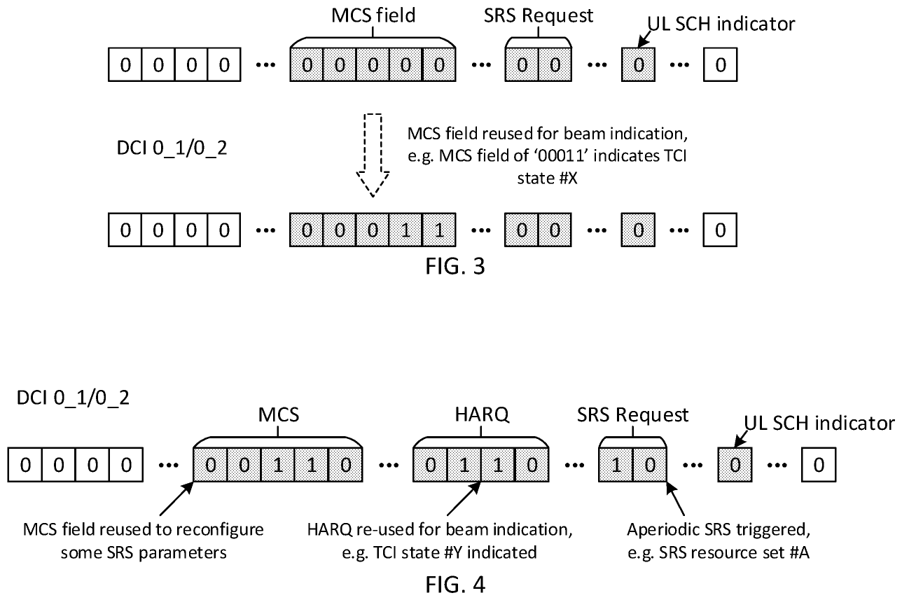

FIG. 4 illustrates un-used fields repurposed for beam indication by DCI 0_1/0_2 without PUSCH, without CSI Request and with SRS triggered, in accordance with some embodiments. Some of the un-used bits could be used to indicate one or several or all of the following:
Common DL/UL TCI state, if common DL/UL TCI state is enabled.
Separate DL/UL TCI state, including DL TCI state and UL TCI state
DL TCI state only
UL TCI state only

In some embodiments, in the scenario of multi-TRP operation, two TCI states could be indicated via DCI format 0_1/0_2 without scheduling PUSCH, without CSI Request and with SRS triggered. Each TCI state is associated with different TRP. Or one codepoint of TCI state could indicate two beams, one for each TRP. There could be implicit or explicit association between the TCI state and TRP. For example, the 1^{st} TCI state corresponding to the 1^{st} TRP, and the 2^{nd} TCI state corresponds to the second TRP. Or there is explicit field(s) indicating which TRP is associated with the TCI state. In order to support dynamic switching between single TRP and multi-TRP operation, additional field(s) could be used to indicate whether the TCI state is present or not. Or a specific value for the TCI state field indicates the TCI state is not valid.

When SRS resource set or multiple SRS resource sets are triggered, which TCI state is applied for the SRS resource set could be further indicated by implicit or explicit association between the SRS resource set and TRP. The association between SRS resource set and TRP could be implicitly indicated by the configured/indicated SRS power control adjustment state. Or explicit association between SRS and TRP could be configured/indicated to the SRS resource set.

In some embodiments, for DCI format 0_1/0_2 without scheduling PUSCH and without CSI Request, if aperiodic SRS is triggered, e.g. the SRS Request field is set to non-zero, some un-used DCI fields could be repurposed for beam indication, wherein the un-used DCI fields are the same as the un-used fields in Case A, e.g. DCI format 0_1/0_2 without scheduling PUSCH, without CSI Request and without SRS triggered.

In some embodiments, for beam indication via DCI format 0_1/0_2 without scheduling PUSCH, without CSI Request and with aperiodic SRS triggered, the successful reception of the triggered aperiodic SRS at the gNB could serve as acknowledgement (ACK) to the beam indication. After receiving the ACK, the gNB side could begin to use the new TCI state for communication.

In some embodiments, in the scenario of carrier aggregation, multiple TCI states could be indicated via DCI format 0_1/0_2 without scheduling PUSCH, without CSI Request and with aperiodic SRS triggered, one TCI state for each component carrier (CC). Or one TCI state is indicated and is applied to multiple CCs. Or one TCI state is indicated, and a bitmap is used to indicate which CC can apply the TCI state.

In some embodiments, for beam indication via DCI format 0_1/0_2 without scheduling PUSCH, without CSI Request and with aperiodic SRS triggered, the indicated TCI state could be applied for the triggered aperiodic SRS transmission if the indicated TCI state is common DL/UL TCI or separate UL TCI state.

In some embodiments, if the time gap between the triggering DCI and the triggered SRS is smaller than certain threshold, wherein the threshold defines the beam application time for beam indication and the threshold could be pre-defined or up to UE capability, then the triggered SRS should utilize the previous beam for transmission instead of the indicated one. If the time gap between the triggering DCI and the triggered SRS is larger than or equal to certain threshold, then the indicated TCI state could be applied for the triggered aperiodic SRS transmission.

In some embodiments, if TCI state is indicated via DCI format 0_1/0_2 without scheduling PUSCH, without CSI Request and with aperiodic SRS triggered, an SR-like over PUCCH could serve as acknowledgement (ACK) to the beam indication. The dedicated SR-like PUCCH resource could be configured to the UE. After receiving the beam indication, the UE could send the SR-like PUCCH for several times, e.g. N times, where N could be configurable or predefined. After the gNB receives the SR-like PUCCH, the gNB assumes the UE has received the beam indication DCI.

In some embodiments, after receiving the beam indication, the UE could send the SR-like PUCCH for several times, e.g. N times. After the gNB receives the SR-like PUCCH, the gNB should send another DCI with UL grant, e.g. PUSCH resource allocation. After the UE receives the UL grant, the UE knows the ACK to beam indication has been received by the gNB.

In some embodiments, if TCI state is indicated via DCI format 0_1/0_2 without scheduling PUSCH, without CSI Request and with aperiodic SRS triggered, the UE should provide HARQ-ACK information in response to the beam indication DCI after N symbols from the last symbol of a PDCCH carrying the beam indication, wherein the value of N could be configurable or pre-defined.

In order to improve flexibility for aperiodic CSI-RS/CSI-IM transmission and/or aperiodic CSI report, the aperiodic CSI-RS/CSI-IM and/or aperiodic CSI report could be triggered by DCI format 0_1/0_2 without scheduling UL-SCH, e.g. UL-SCH indicator is set to ‘0’, and CSI Request field is set to non-zeros.

If the DCI format 0_1/0_2 without scheduling UL-SCH also doesn't trigger aperiodic SRS, e.g. SRS Request is set to all zeros, then the un-used DCI fields could be repurposed to dynamically configure CSI-RS/CSI-IM and/or CSI report parameters to facilitate aperiodic CSI-RS triggering/CSI-IM and/or CSI report and transmission. If the DCI format 0_1/0_2 without scheduling UL-SCH also triggers aperiodic SRS, e.g. SRS Request is set to non-zeros, then the un-used DCI fields could be repurposed to dynamically configure both CSI-RS/CSI-M and/or CSI report parameters and SRS parameters to facilitate CSI-RS/CSI-IM and/or CSI report and SRS transmission.

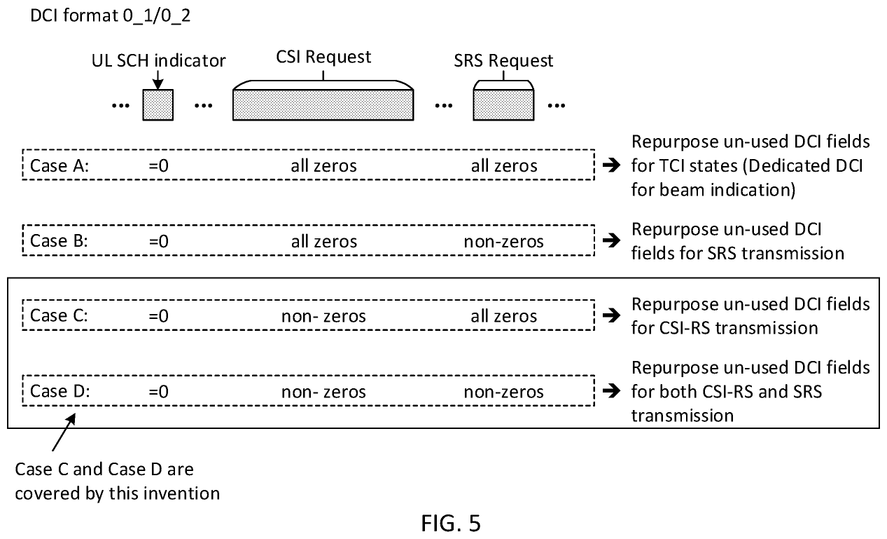

FIG. 5 illustrates different cases on re-using fields for DCI 0_1/0_2, in accordance with some embodiments. The current DCI format 0_1/0_2 without scheduling UL-SCH doesn't consider utilizing some un-used DCI fields to reconfigure CSI-RS/CSI-EICSI report parameters. Various embodiments herein provide techniques to reconfigure CSI-RS/CSI-IM/CSI report/SRS parameters via DCI format 0_1/0_2 without scheduling UL-SCH.

Scenario-1: Dci Format 0_1/0_2 without Scheduling Ul-Sch, without Srs Triggered, with Csi-Rs Csi-Im and/or Csi Report Triggered

In some embodiments, for DCI format 0_1/0_2, it is allowed that the field of UL-SCH indicator is present (1 bit) and set to ‘0’, SRS Request field is set to all zero(s), and CSI Request field is set to non-zero value. In this case, the un-used DCI fields could be re-purposed to reconfigure some CSI-RS/CSI-IM and/or CSI report parameters to facilitate the aperiodic CSI-RS/CSI-IM and/or aperiodic CSI report transmission, for example, the field of MCS, HARQ, Redundancy version, New data indicator, TPC command for PUSCH, etc.

In some embodiments, for aperiodic CSI-RS triggered by DCI format 0_1/0_2 without scheduling UL-SCH and without triggering SRS, some un-used field(s) could be utilized to reconfigure the resource allocation for the triggered CSI-RS, including frequency domain and time domain resource allocation.

Some (including one) of or all the following parameters on resource allocation for the triggered CSI-RS could be reconfigured by un-used DCI fields:
CSI-RS-ResourceMapping, including
frequencyDomainAllocation
nrofPorts
firstOFDMSymbolInTimeDomain
firstOFDMSymbolInTimeDomain2
cdm-Type
density, indicating the CSI-RS frequency density
freqBand (including startingRB, and nrofRBs)
BWP-Id, indicating in which BWP the CSI-RS is transmitted
powerControlOffset, the ratio of PDSCH EPRE to NZP CSI-RS EPRE
powerControlOffsetSS, the ratio of NZP CSI-RS EPRE to SS/PBCH block EPRE

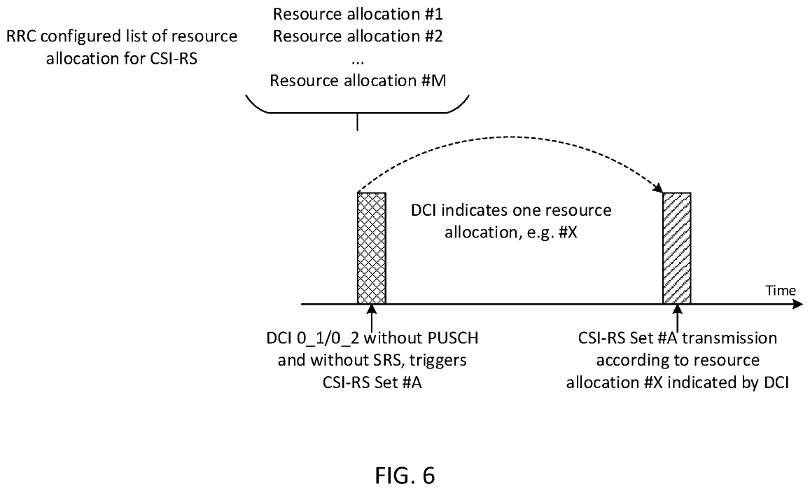

In some embodiments, for aperiodic CSI-RS triggered by DCI format 0_1/0_2 without scheduling UL-SCH and without SRS Request, a list of resource allocations could be configured by RRC, for example, a list of M resource allocation is configured by RRC. The list of resource allocation could be introduced into CSI-RS resource set level, or CSI-RS resource level. In the DCI, some unused bits can be used to dynamically indicate one or several resource allocations from the M configured allocations, which will be applied for the CSI-RS transmission triggered by the DCI. FIG. 6. illustrates DCI indicated resource allocation for CSI-RS transmission, in accordance with some embodiments.

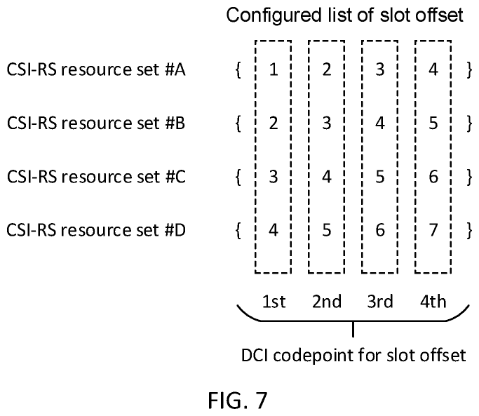

In some embodiments, for aperiodic CSI-RS triggered by DCI format 0_1/0_2 without scheduling UL-SCH and without triggering SRS, some un-used field(s) could be utilized to dynamically indicate the slot offset for the triggered aperiodic CSI-RS resource set(s). The value of the slot offset could be indicated by the binary value of the DCI field. Or a list of slot offsets values could be configured by RRC per CSI-RS resource set, and the DCI codepoint indicate one value from the list. If multiple CSI-RS resource sets are triggered by the same DCI, the same DCI codepoint could indicate different slot offset values for different CSI-RS resource set. For example, CSI-RS resource set #A is configured with slot offset value list of {1, 2, 3} (it means the 1^{st} DCI code point can indicate slot offset of ‘1’, the 2^{nd} DCI code point can indicate slot offset of ‘2’, and so on.) and CSI-RS resource set #B is configured with slot offset value list of {2, 3, 4}. If CSI-RS resource set #A and #B are triggered by the same DCI, then the same DCI codepoint for slot offset can indicate different slot offset value. For example, the 1^{st} DCI codepoint will indicate slot offset ‘1’ for CSI-RS resource set #A, and slot offset ‘2’ for CSI-RS resource set #B. FIG. 7 illustrates DCI indicated slot offset for CSI-RS, in accordance with some embodiments.

In some embodiments, for DCI indicated slot offset for CSI-RS, the reference slot could be the slot carrying the DCI that triggers the aperiodic CSI-RS. In some embodiments, the slot offset value of ‘x’ means slot ‘x’ after the reference slot. In some embodiments, the slot offset could be interpreted as an available slot after the reference slot. One slot is defined as ‘available slot’ for CSI-RS if the slot is a downlink slot. Alternatively, one slot is defined as ‘available slot’ for CSI-RS if the slot is:
A downlink (DL) slot
Or a flexible slot and the OFDM symbol positions configured for CSI-RS are downlink (DL) symbol(s) or flexible symbol(s)
In some embodiments, for DCI indicated slot offset for CSI-RS, the reference slot could be the slot indicated by the legacy RRC parameter aperiodicTriggeringOffset or aperiodicTriggeringOffset-r16.

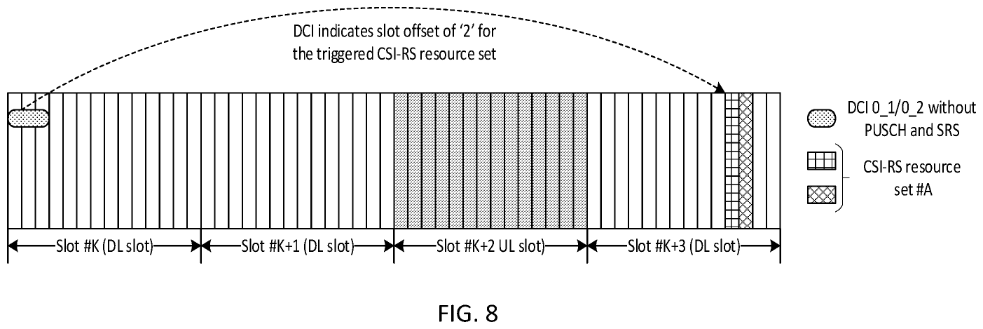

FIG. 8 illustrates an example of indicated available slot for CSI-RS by DCI format 0_1/0_2 without scheduling UL-SCH and without triggering SRS, in accordance with some embodiments. In the example, CSI-RS resource set #A contains two CSI-RS resources. If the DCI indicated slot offset is ‘2’ for CSI-RS resource set #A, then CSI-RS resource set #A is transmitted over Slot K+3, because slot K+2 is UL slot and it is not counted as available slot for CSI-RS.

In some embodiments, the slot offset by legacy RRC parameter aperiodicTriggeringOffset or aperiodicTriggeringOffset-r16 could be interpreted as an available slot for CSI-RS after the triggering DCI.

In some embodiments, for aperiodic CSI-RS triggered by DCI format 0_1/0_2 without scheduling UL-SCH and without triggering SRS, some un-used field(s) could be utilized to indicate multiple component carriers (CCs) over which the CSI-RS will be transmitted. For example, a bitmap of CCs could be introduced to occupy some un-used DCI field(s). And CC-specific slot offset could be applied, e.g. by the same DCI triggering the same CSI-RS trigger state, different slot offset could be applied for the CSI-RS transmission over different CCs. For example, for the triggered CSI-RS resource set #A, the slot offset for CC #1 will be ‘2’, and the slot offset for CC #2 will be ‘3’.

In some embodiments, for aperiodic CSI-RS triggered by DCI format 0_1/0_2 without scheduling UL-SCH and without triggering SRS, some un-used field(s) could be utilized to indicate the TCI state for the triggered CSI-RS. The DCI indicated TCI-state for CSI-RS could be the legacy TCI sate in Rel-15/Rel-16, or it could be the common DL/UL TCI state, separate DL/UL TCI state defined in Rel-17.

If the time gap between the last symbol of the triggering DCI and the first symbol of the triggered aperiodic CSI-RS is smaller than certain threshold, wherein the threshold could be up to UE capability, then the UE should apply a default beam for the CSI-RS reception. Otherwise, the UE could apply the indicted TCI state for the CSI-RS reception.

In the scenario of multi-TRP operation, two TCI states could be indicated via DCI format 0_1/0_2 without scheduling UL-SCH, and without triggering SRS. Each TCI state is associated with different TRP. Or one codepoint of TCI state could indicate two beams, one for each TRP. There could be implicit or explicit association between the TCI state and TRP. For example, the 1^{st} TCI state corresponding to the 1^{st} TRP, and the 2^{nd} TCI state corresponds to the second TRP. Or there is explicit field(s) indicating which TRP is associated with the TCI state. In order to support dynamic switching between single TRP and multi-TRP operation, additional field(s) could be used to indicate whether the TCI state is present or not. Or a specific value for the TCI state field indicates the TCI state is not valid.

When CSI-RS resource set or multiple CSI-RS resource sets are triggered, which TCI state is applied for the CSI-RS resource set could be further indicated by implicit or explicit association between the CSI-RS resource set and TRP.

In some embodiments, in the scenario of carrier aggregation, multiple TCI states could be indicated via DCI format 0_1/0_2 without scheduling UL-SCH, and without triggering SRS, one TCI state for each component carrier (CC). Or one TCI state is indicated and is applied to multiple CCs. Or one TCI state is indicated, and a bitmap is used to indicate which CC can apply the TCI state.

In some embodiments, if TCI state is indicated via DCI format 0_1/0_2 without scheduling UL-SCH, and without triggering SRS, an SR-like over PUCCH could serve as acknowledgement (ACK) to the beam indication. The dedicated SR-like PUCCH resource could be configured to the UE. After receiving the beam indication, the UE could send the SR-like PUCCH for several times, e.g. N times, where N could be configurable or predefined. After the gNB receives the SR-like PUCCH, the gNB assumes the UE has received the beam indication DCI.

In some embodiments, after receiving the beam indication, the UE could send the SR-like PUCCH for several times, e.g. N times. After the gNB receives the SR-like PUCCH, the gNB should send another DCI with UL grant, e.g. PUSCH resource allocation. After the UE receives the UL grant, the UE knows the ACK to beam indication has been received by the gNB.

In some embodiments, if TCI state is indicated via DCI format 0_1/0_2 without scheduling UL-SCH, and without triggering SRS, the UE should provide HARQ-ACK information in response to the beam indication DCI after N symbols from the last symbol of a PDCCH carrying the beam indication, wherein the value of N could be configurable or pre-defined.

In some embodiments, if TCI state is indicated via DCI format 0_1/0_2 without scheduling UL-SCH, and without triggering SRS, the CSI-Report could serve as acknowledgement (ACK) to the beam indication if CSI-Report is also triggered by the DCI.

In some embodiments, for aperiodic CSI-RS triggered by DCI format 0_1/0_2 without scheduling UL-SCH and without triggering SRS, if the DCI dynamically changes the CSI-RS configuration except TCI state, then the changed configuration only applies to the CSI-RS transmission triggered by the same DCI. Later on, if the same aperiodic CSI-RS resource set is triggered by another DCI, then the previous configuration by RRC should be applied.

In some embodiments, for aperiodic CSI-RS triggered by DCI format 0_1/0_2 without scheduling UL-SCH and without triggering SRS, if the DCI dynamically changes the CSI-RS configuration, then the changed configuration could also be applied to the same CSI-RS resource set(s) in future transmission triggered by another DCI.

Scenario-2: DCI Format 0_1/0_2 without Scheduling UL-SCH, with SRS Triggered, with CSI-RS CSI-IM and/or CSI Report Triggered

In some embodiments, for DCI format 0_1/0_2, it is allowed that the field of UL-SCH indicator is present (1 bit) and set to ‘0’, SRS Request field is set non-zero value, and CSI Request field is set to non-zero value. In this case, the un-used DCI fields could be re-purposed to reconfigure some CSI-RS/CSI-IM and/or CSI report parameters and SRS parameters to facilitate the aperiodic CSI-RS/CSI-IM and/or aperiodic CSI report and aperiodic SRS transmission.

In some embodiments, for DCI format 0_1/0_2 without scheduling UL-SCH and with CSI-RS/CSI-IM/CSI report and SRS triggered, the embodiments in Scenario-1 could be applied. The unused DCI fields which are repurposed for CSI-RS could be the same or different in Scenario-1 and Scenario-2.

In some embodiments, for DCI format 0_1/0_2 without scheduling UL-SCH and with CSI-RS and SRS triggered, the following parameters for SRS transmission could be reconfigured by the DCI via un-used DCI field(s).

The frequency resource allocation, which could include some of or all the following parameters. Or a list of the frequency resource allocation could be configured by RRC, and DCI will indicate one.
nrofSRS-Ports, indicating the number of antenna ports for SRS
ptrs-Portlndex, indicating the PTRS port for the SRS
transmissionComb, indicating the comb for SRS, comb offset and cyclic shift
freqDomainPosition, indicating the frequency position
freqDomainShift, indicating the frequency shift
freqHopping {including c-SRS, b-SRS, b-hop}, parameters for frequency hopping
groupOrSequenceHopping, indicating whether group or sequence hopping is enabled or not

The time resource allocation, which could include some of or all the following parameters. Or a list of the time resource allocation could be configured by RRC, and DCI will indicate one.
startPosition, indicating the starting OFDM symbols for SRS
nrofSymbols, indicating the number of OFDM symbols for SRS
repetitionFactor, indicating the repetition factor for SRS
The SRS power control parameters, which could include some of or all the following parameters. Or a list of the SRS power control parameters could be configured by RRC, and DCI will indicate one.
SRS power control adjustment state
Pathloss reference signal
Spatial relation
P0 and alpha value
TPC accumulation
The slot offset of the triggered SRS resource set, which can indicate an available slot for the triggered SRS resource set(s).
The usage of the SRS resource set. For example, the SRS resource set for codebook could be reconfigured as SRS resource set for antenna switching.
The TCI state. It could be the common DL/UL TCI state, or separate DL/UL TCI state.

In some embodiments, for aperiodic SRS triggered by DCI format 0_1/0_2 without scheduling UL-SCH and with CSI-RS/CSI-IM/CSI report and SRS triggered, if the DCI indicate the TCI state, the triggered SRS could use the indicated TCI state (beam) for transmission if applicable (Or the triggered SRS could use the previous beam for transmission). The successful reception of the triggered aperiodic SRS at the gNB could serve as acknowledgement (ACK) to the beam indication. After receiving the ACK, the gNB side could begin to use the new TCI state for communication.

In some embodiments, if TCI state is indicated via DCI format 0_1/0_2 without scheduling UL-SCH, and with CSI-RS/CSI-IM/CSI report and SRS triggered, an SR-like over PUCCH could serve as acknowledgement (ACK) to the beam indication. The dedicated SR-like PUCCH resource could be configured to the UE. After receiving the beam indication, the UE could send the SR-like PUCCH for several times, e.g. N times, where N could be configurable or predefined. After the gNB receives the SR-like PUCCH, the gNB assumes the UE has received the beam indication DCI.

In some embodiments, after receiving the beam indication, the UE could send the SR-like PUCCH for several times, e.g. N times. After the gNB receives the SR-like PUCCH, the gNB should send another DCI with UL grant, e.g. PUSCH resource allocation. After the UE receives the UL grant, the UE knows the ACK to beam indication has been received by the gNB.

In some embodiments, if TCI state is indicated via DCI format 0_1/0_2 without scheduling UL-SCH, and with CSI-RS/CSI-IM/CSI report and SRS triggered, the UE should provide HARQ-ACK information in response to the beam indication DCI after N symbols from the last symbol of a PDCCH carrying the beam indication, wherein the value of N could be configurable or pre-defined.

In some embodiments, for aperiodic SRS triggered by DCI format 0_1/0_2 without scheduling UL-SCH and with CSI-RS/CSI-IM/CSI report and SRS triggered, if the DCI dynamically changes the SRS configuration except TCI state, such as {frequency resource allocation, time resource allocation, power control parameters, slot offset, usages}, then the changed configuration only applies to the SRS transmission triggered by the same DCI. Later on, if the same aperiodic SRS resource set is triggered by another DCI, then the previous configuration by RRC should be applied.

In some embodiments, for aperiodic SRS triggered by DCI format 0_1/0_2 without scheduling UL-SCH and with CSI-RS/CSI-IM/CSI report and SRS triggered, if the DCI dynamically changes the SRS configuration, then the changed configuration could also be applied to the same SRS resource set(s) in future transmission triggered by another DCI.

In some embodiments, for aperiodic SRS triggered by DCI format 0_1/0_2 without scheduling UL-SCH and with CSI-RS/CSI-IM/CSI report and SRS triggered, if the DCI dynamically changes the SRS configuration, after the gNB receives the SRS following the indicated configuration, then changed SRS configuration could be applied to the same SRS resource set(s) in future transmissions.

For downlink DCI format 1_1/1_2, it can be scrambled by C-RNTI, MCS-CRNTI or CS-RNTI. When the DCI is scrambled by CS-RNTI, it could be used to activate/release the downlink semi-persistent PDSCH scheduling. Table 2 shows the detailed fields and field length for DCI format 1_1 as defined by 3GPP TS 38.212 v16.4.0.

TABLE 2
Field length for downlink DCI format 1_1 and 1_2

| Field | DCI format 1_1 |
|---|---|
| Identifier for DCI format | 1 |
| Carrier Indicator (CIF) | 0/3 |
| Bandwidth part (BWP) indicator | 0/1/2 |
| Frequency domain resource assignment | Up to configuration |
| (FDRA) | |
| Time domain resource assignment (TDRA) | 0/1/2/3/4 |
| VRB-to-PRB mapping | 0/1 |
| PRB bundling size indicator | 0/1 |
| Rate matching indicator | 0/1/2 |
| ZP CSI-RS trigger | 0/1/2 |
| For TB1: Modulation and coding scheme | 5 |
| (MCS) | |
| For TB1: New data indicator (NDI) | 1 |
| For TB1: Redundancy version (RV) | 2 |
| For TB2: Modulation and coding scheme | 5 |
| (MCS) | |
| For TB2: New data indicator (NDI) | 1 |
| For TB2: Redundancy version (RV) | 2 |
| HARQ process number | 4 |
| Downlink assignment index (DAI) | 0/2/4/6 |
| TPC command for scheduled PUCCH | 2 |
| PUCCH resource indicator | 3 |
| PDSCH-to-HARQ_feedback timing | 0/1/2/3 |
| indicator | |
| One-shot HARQ-ACK request | 0/1 |
| PDSCH group index | 0/1 |
| New feedback indicator | 0/1/2 |
| Number of requested PDSCH group(s) | 0/1 |
| Antenna port(s) | 4/5/6 |
| Transmission configuration indication (TCI) | 0/3 |
| SRS Request | 2 |
| CBG transmission information (CBGTI) | 0/2/4/6/8 |
| CBG flushing out information | 0/1 |
| DMRS sequence initialization | 1 |
| Priority indicator | 0/1 |
| ChannelAccess-CPex | 0/1/2/3/4 |
| Minimum applicable scheduling offset | 0/1 |
| indicator | |
| SCell dormancy indication | 0/1/2/3/4/5 |

For CSI-RS, it is triggered by CSI Request field which is included in uplink DCI format 0_1/0_2. In order to improve flexibility, for downlink DCI format 1_1/1_2, if there is no downlink data scheduled, some fields in the DCI is not used and it could be re-used to reconfigure some SRS parameters. In addition, if there is no downlink data scheduled in DCI format 1_1/1_2 then some un-used bits could be re-used to trigger CSI-RS which doesn't require CSI report over uplink. Another case is if there is no downlink data scheduled in DCI format 1_1/1_2, then some un-used bits could be re-used to reconfigure some parameters for PUCCH transmission.

The current downlink DCI format 1_1/1_2 without scheduling PDSCH doesn't consider utilizing some un-used DCI fields to reconfigure SRS parameters. And CSI-RS can't be triggered by DCI format 1_1/1_2. Various embodiments herein provide techniques to reconfigure SRS parameters via DCI format 1_1/1_2 without scheduling PDSCH. And some un-used fields could be re-used to trigger CSI-RS.

Scenario-1: Repurpose Un-Used Fields in DCI Format 1_1/0_2 without Scheduling PDSCH for SRS

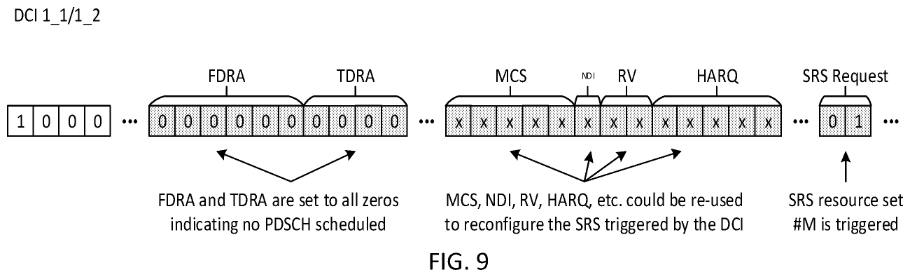

FIG. 9 illustrates repurposed unused fields for SRS triggered by DCI format 1_1/1_2 without scheduling PDSCH, in accordance with some embodiments. In some embodiments, for downlink DCI format 1_1/1_2 scrambled by C-RNTI or MCS-C-RNTI, if there is no PDSCH scheduled, e.g. the FDRA and TDRA fields are set to all zeros, then some un-used fields could be repurposed to reconfigure the parameters for the SRS triggered by the DCI.

In some embodiments, for downlink DCI format 1_1/1_2 without scheduling PDSCH, the following parameters for SRS transmission could be reconfigured for the triggered SRS by the DCI via un-used DCI field(s).

The frequency resource allocation, which could include some of or all the following parameters. Or a list of the frequency resource allocation could be configured by RRC, and DCI will indicate one.
nrofSRS-Ports, indicating the number of antenna ports for SRS
ptrs-Portlndex, indicating the PTRS port for the SRS
transmissionComb, indicating the comb for SRS, comb offset and cyclic shift
freqDomainPosition, indicating the frequency position
freqDomainShift, indicating the frequency shift
freqHopping {including c-SRS, b-SRS, b-hop}, parameters for frequency hopping
groupOrSequenceHopping, indicating whether group or sequence hopping is enabled or not
Indicator of DL/UL BWP, indicating whether the SRS transmission should follow the bandwidth of uplink BWP or downlink BWP.
BWP ID, indicating which BWP the SRS transmission should be performed. The BWP ID could be different with the current active BWP, e.g. the SRS transmission could be over a different BWP and the UE should switch back to the active BWP after SRS transmission.

The time resource allocation, which could include some of or all the following parameters. Or a list of the time resource allocation could be configured by RRC, and DCI will indicate one.
startPosition, indicating the starting OFDM symbols for SRS
nrofSymbols, indicating the number of OFDM symbols for SRS
repetitionFactor, indicating the repetition factor for SRS

The SRS power control parameters, which could include some of or all the following parameters. Or a list of the SRS power control parameters could be configured by RRC, and DCI will indicate one.
SRS power control adjustment state
Pathloss reference signal
Spatial relation
P0 and alpha value
TPC accumulation
The slot offset of the triggered SRS resource set, which can indicate an available slot for the triggered SRS resource set(s).
The usage of the SRS resource set. For example, the SRS resource set for codebook could be reconfigured as SRS resource set for antenna switching.
The TCI state. It could be the common DL/UL TCI state, or separate DL/UL TCI state.
etc.

In some embodiments, for DCI format 1_1/1_2 without scheduling PDSCH and with aperiodic SRS triggered, it is allowed that PUCCH resource is not triggered by the DCI.

In some embodiments, the carrier indictor in DCI format 1_1/1_2 without scheduling PDSCH could trigger cross carrier SRS transmission. E.g. the SRS will be triggered to be transmitted over a different carrier other than the carrier carrying the trigger DCI.

In some embodiments, the carrier indicator could be repurposed as a bitmap and can trigger SRS transmission over multiple carriers. In this case, the list of the values on available slot in each SRS resource set should be configured for each carrier.

In some embodiments, for DCI format 1_1/1_2 without scheduling PDSCH, if the DCI triggers aperiodic SRS, then the field of carrier indicator will be discarded by the UE.

In some embodiments, for aperiodic SRS triggered by DCI format 1_1/1_2 without scheduling PDSCH, the field of BWP Indicator is still used for BWP switching command. The UE does not expect to receive the DCI 1_1/1_2 without scheduling PDSCH and with aperiodic SRS triggered, wherein the DCI includes BWP indicator indicating downlink and/or uplink BWP change, if the time offset between the DCI and the transmission of the first SRS is less than the delay requirement by the UE for downlink and/or uplink BWP change. E.g. if the time offset between the DCI and the transmission of the first SRS is less than the delay requirement for active BWP change, the BWP indicator indicating BWP change is not valid.

In some embodiments, for aperiodic SRS triggered by DCI format 1_1/1_2 without scheduling PDSCH, the field of BWP Indicator is discarded by the UE, e.g. it is not used for BWP switching or it is viewed as an invalid BWP switching command.

In some embodiments, the BWP indicator could be repurposed for other usage, for example to reconfigure some SRS parameters.

In some embodiments, for aperiodic SRS triggered by DCI format 1_1/1_2 without scheduling PDSCH, the field of TDRA is not repurposed for other usage. The BWP indicator is still used as BWP switching command. Whether it is valid BWP command still follows the existing rules, e.g. it is not valid if the time offset for PDSCH indicated TDRA is smaller than the delay requirement for active BWP change.

In some embodiments, if the UE receives DCI format 1_1/1_2 without scheduling PDSCH which triggers aperiodic SRS, then the MAC layer in the UE should start or re-start the bwp-InactivityTimer. Or the DCI format 1_1/1_2 without scheduling PDSCH which triggers aperiodic SRS is considered as downlink assignment/uplink grant or dynamic downlink assignment/uplink grant.

In some embodiments, the DCI format 1_1/1_2 without scheduling PDSCH which triggers aperiodic SRS doesn't impact the running of bwp-InactivityTimer in MAC layer.

Scenario-2: Repurpose Un-Used Fields in DCI Format 1_1/1_2 without Scheduling PDSCH for CSI-RS

In some embodiments, for downlink DCI format 1_1/1_2 scrambled by C-RNTI or MCS-C-RNTI, if there is no PDSCH scheduled, e.g. the FDRA and TDRA fields are set to all zeros, then some un-used fields could be repurposed to trigger CSI-RS which doesn't require CSI report over uplink. And some other un-used fields could be repurposed to reconfigure parameters for CSI-RS transmission triggered by the DCI. The same DCI may or may not trigger aperiodic SRS.

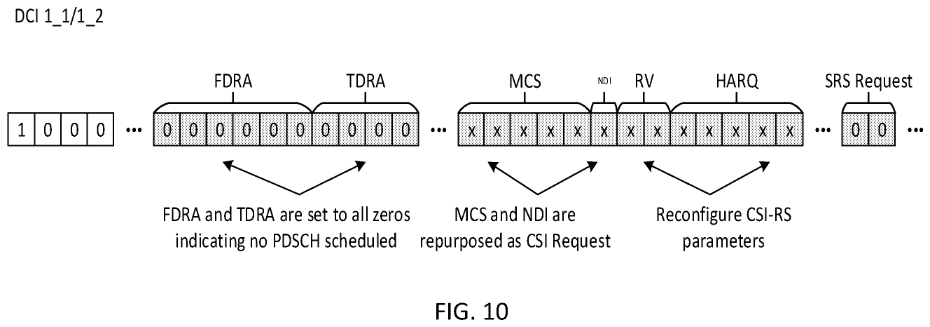

FIG. 10 illustrates a CSI-RS triggered by DCI format 1_1/1_2 without scheduling PDSCH, in accordance with some embodiments. In the example, the MCS field and NDI field is repurposed as CSI Request to triggered CSI-RS which doesn't require CSI Report. RV field and HARQ field is repurposed to reconfigure CSI-RS parameters.

In some embodiments, for aperiodic CSI-RS triggered by downlink DCI format 1_1/1_2 without scheduling PDSCH, some un-used field(s) could be utilized to reconfigure the resource allocation for the triggered CSI-RS, including frequency domain and time domain resource allocation.

In an example, some (including one) of or all the following parameters on resource allocation for the triggered CSI-RS could be reconfigured by un-used DCI fields:
CSI-RS-ResourceMapping, including
frequencyDomainAllocation
nrofPorts
firstOFDMSymbolInTimeDomain
firstOFDMSymbolInTimeDomain2
cdm-Type
density, indicating the CSI-RS frequency density
freqBand (including startingRB, and nrofRBs)
BWP-Id, indicating in which BWP the CSI-RS is transmitted
powerControlOffset, the ratio of PDSCH EPRE to NZP CSI-RS EPRE
powerControlOffsetSS, the ratio of NZP CSI-RS EPRE to SS/PBCH block EPRE
Slot offset of the triggered CSI-RS resource set, indicating an available slot for the CSI-RS resource set
etc.

In some embodiments, for DCI format 1_1/1_2 without scheduling PDSCH and with aperiodic CSI-RS triggered, it is allowed that PUCCH resource is not triggered by the DCI.

In some embodiments, the carrier indictor in DCI format 1_1/1_2 without scheduling PDSCH could trigger cross carrier CSI-RS transmission. E.g. the CSI-RS will be triggered to be transmitted over a different carrier other than the carrier carrying the trigger DCI.

In some embodiments, the carrier indicator could be repurposed as a bitmap and can trigger CSI-RS transmission over multiple carriers. In this case, the list of the values on available slot in each CSI-RS resource set should be configured for each carrier.

In some embodiments, for DCI format 1_1/1_2 without scheduling PDSCH, if the DCI triggers aperiodic CSI-RS, then the field of carrier indicator will be discarded by the UE.

In some embodiments, for DCI format 1_1/1_2 without scheduling PDSCH and with CSI-RS triggered, the field of BWP Indicator is still used for BWP switching command. The UE does not expect to receive the DCI 1_1/1_2 without scheduling PDSCH and with aperiodic CSI-RS triggered, wherein the DCI includes BWP indicator indicating downlink BWP change, if the time offset between the DCI and the transmission of the first CSI-RS is less than the delay requirement by the UE for downlink BWP change. E.g. if the time offset between the DCI and the transmission of the first CSI-RS is less than the delay requirement for active BWP change, the BWP indicator indicating BWP change is not valid.

In some embodiments, for aperiodic CSI-RS triggered by DCI format 1_1/1_2 without scheduling PDSCH, the field of BWP Indicator is discarded by the UE, e.g. it is not used for BWP switching or it is viewed as an invalid BWP switching command.

In some embodiments, the BWP indicator could be repurposed for other usage, for example to reconfigure some CSI-RS parameters.

In some embodiments, for aperiodic CSI-RS triggered by DCI format 1_1/1_2 without scheduling PDSCH, the field of TDRA is not repurposed for other usage. The BWP indicator is still used as BWP switching command. Whether it is valid BWP command still follows the existing rules, e.g. it is not valid if the time offset for PDSCH indicated TDRA is smaller than the delay requirement for active BWP change.

In some embodiments, if the UE receives DCI format 1_1/1_2 without scheduling PDSCH which triggers aperiodic CSI-RS, then the MAC layer in the UE should start or re-start the bwp-InactivityTimer. Or the DCI format 1_1/1_2 without scheduling PDSCH which triggers aperiodic CSI-RS is considered as downlink assignment or dynamic downlink assignment.

In some embodiments, the DCI format 1_1/1_2 without scheduling PDSCH which triggers aperiodic CSI-RS doesn't impact the running of bwp-InactivityTimer in MAC layer.

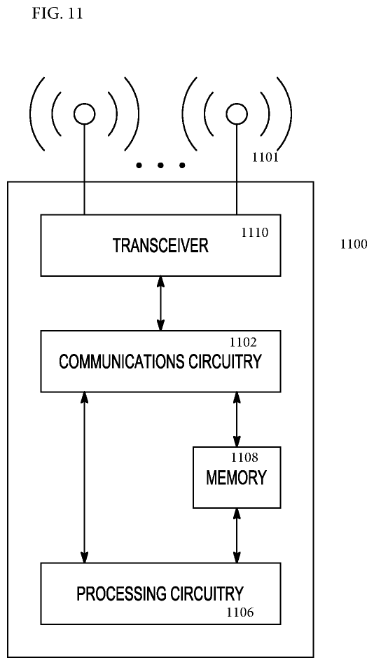

FIG. 11 illustrates a functional block diagram of a wireless communication device, in accordance with some embodiments. Wireless communication device 1100 may be suitable for use as a UE or gNB configured for operation in a 5G NR network.

The communication device 1100 may include communications circuitry 1102 and a transceiver 1110 for transmitting and receiving signals to and from other communication devices using one or more antennas 1101. The communications circuitry 1102 may include circuitry that can operate the physical layer (PHY) communications and/or medium access control (MAC) communications for controlling access to the wireless medium, and/or any other communications layers for transmitting and receiving signals. The communication device 1100 may also include processing circuitry 1106 and memory 1108 arranged to perform the operations described herein. In some embodiments, the communications circuitry 1102 and the processing circuitry 1106 may be configured to perform operations detailed in the above figures, diagrams, and flows.

In accordance with some embodiments, the communications circuitry 1102 may be arranged to contend for a wireless medium and configure frames or packets for communicating over the wireless medium. The communications circuitry 1102 may be arranged to transmit and receive signals. The communications circuitry 1102 may also include circuitry for modulation/demodulation, upconversion/downconversion, filtering, amplification, etc. In some embodiments, the processing circuitry 1106 of the communication device 1100 may include one or more processors. In other embodiments, two or more antennas 1101 may be coupled to the communications circuitry 1102 arranged for sending and receiving signals. The memory 1108 may store information for configuring the processing circuitry 1106 to perform operations for configuring and transmitting message frames and performing the various operations described herein. The memory 1108 may include any type of memory, including non-transitory memory, for storing information in a form readable by a machine (e.g., a computer). For example, the memory 1108 may include a computer-readable storage device, read-only memory (ROM), random-access memory (RAM), magnetic disk storage media, optical storage media, flash-memory devices and other storage devices and media.

In some embodiments, the communication device 1100 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication device 1100 may include one or more antennas 1101. The antennas 1101 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the communication device 1100 may include one or more of a keyboard, a display, a non-volatile memory port, multiple antennas, a graphics processor, an application processor, speakers, and other mobile device elements. The display may be an LCD screen including a touch screen.

Although the communication device 1100 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication device 1100 may refer to one or more processes operating on one or more processing elements.

### EXAMPLES

Example 1 may include a method of a gNB, wherein the gNB could send downlink control information (DCI) to the UE, wherein the DCI format could be 0_1/0_2.

Example 2 may include the method of example 1 or some other example herein, wherein for DCI format 0_1/0_2, it is allowed that the field of UL-SCH indicator is present (1 bit) and set to ‘0’, CSI Request field is set to all zero(s), and SRS Request field is set to all zero(s). In this case, some un-used DCI fields could be repurposed for beam indication, for example, the MCS field, HARQ field, etc.

Example 3 may include the method of example 2 or some other example herein, wherein some of the un-used bits in DCI 0_1/0_2 could be used to indicate one or several or all of the following: Common DL/UL TCI state, if common DL/UL TCI state is enabled. Separate DL/UL TCI state, including DL TCI state and UL TCI state, DL TCI state only, UL TCI state only.

Example 4 may include the method of example 2 and example 3 or some other example herein, wherein in the scenario of multi-TRP operation, two TCI states could be indicated via DCI format 0_1/0_2 without scheduling PUSCH, without CSI Request and without SRS triggered. Each TCI state is associated with different TRP. Or one codepoint of TCI state could indicate two beams, one for each TRP. There could be implicit or explicit association between the TCI state and TRP. For example, the 1^{st} TCI state corresponding to the 1^{st} TRP, and the 2nd TCI state corresponds to the second TRP. Or there is explicit field(s) indicating which TRP is associated with the TCI state. In order to support dynamic switching between single TRP and multi-TRP operation, additional field(s) could be used to indicate whether the TCI state is present or not. Or a specific value for the TCI state field indicates the TCI state is not valid.

Example 5 may include the method of example 2 and example 3 or some other example herein, wherein in the scenario of carrier aggregation, multiple TCI states could be indicated via DCI format 0_1/0_2 without scheduling PUSCH, without CSI Request and without SRS triggered, one TCI state for each component carrier (CC). Or one TCI state is indicated and is applied to multiple CCs. Or one TCI state is indicated, and a bitmap is used to indicate which CC can apply the TCI state.

Example 6 may include the method of example 2 and example 3 or some other example herein, wherein if TCI state is indicated via DCI format 0_1/0_2 without scheduling PUSCH, without CSI Request and without SRS triggered, an SR-like over PUCCH could serve as acknowledgement (ACK) to the beam indication. The dedicated SR-like PUCCH resource could be configured to the UE. After receiving the beam indication, the UE could send the SR-like PUCCH for several times, e.g. N times, where N could be configurable or predefined. After the gNB receives the SR-like PUCCH, the gNB assumes the UE has received the beam indication DCI. In another example, after receiving the beam indication, the UE could send the SR-like PUCCH for several times, e.g. N times. After the gNB receives the SR-like PUCCH, the gNB should send another DCI with UL grant, e.g. PUSCH resource allocation. After the UE receives the UL grant, the UE knows the ACK to beam indication has been received by the gNB.

Example 7 may include the method of example 2 and example 3 or some other example herein, wherein if TCI state is indicated via DCI format 0_1/0_2 without scheduling PUSCH, without CSI Request and without SRS triggered, the UE should provide HARQ-ACK information in response to the beam indication DCI after N symbols from the last symbol of a PDCCH carrying the beam indication, wherein the value of N could be configurable or pre-defined.

Example 8 may include the method of example 1 or some other example herein, wherein for DCI format 0_1/0_2 without scheduling PUSCH and without CSI Request, if aperiodic SRS is triggered, e.g. the SRS Request field is set to non-zero, some un-used DCI fields could be repurposed for beam indication, wherein the un-used DCI fields might be different as the un-used fields in the case of DCI format 0_1/0_2 without scheduling PUSCH, without CSI Request and without SRS triggered.

Example 9 may include the method of example 8 or some other example herein, wherein Some of the un-used bits could be used to indicate one or several or all of the following: Common DL/UL TCI state, if common DL/UL TCI state is enabled. Separate DL/UL TCI state, including DL TCI state and UL TCI state, DL TCI state only, UL TCI state only.

Example 10 may include the method of example 8 and example 9 or some other example herein, wherein in the scenario of multi-TRP operation, two TCI states could be indicated via DCI format 0_1/0_2 without scheduling PUSCH, without CSI Request and with SRS triggered. Each TCI state is associated with different TRP. Or one codepoint of TCI state could indicate two beams, one for each TRP. There could be implicit or explicit association between the TCI state and TRP. For example, the 1^{st} TCI state corresponding to the 1^{st} TRP, and the 2nd TCI state corresponds to the second TRP. Or there is explicit field(s) indicating which TRP is associated with the TCI state. In order to support dynamic switching between single TRP and multi-TRP operation, additional field(s) could be used to indicate whether the TCI state is present or not. Or a specific value for the TCI state field indicates the TCI state is not valid. When SRS resource set or multiple SRS resource sets are triggered, which TCI state is applied for the SRS resource set could be further indicated by implicit or explicit association between the SRS resource set and TRP. The association between SRS resource set and TRP could be implicitly indicated by the configured/indicated SRS power control adjustment state. Or explicit association between SRS and TRP could be configured/indicated to the SRS resource set.

Example 11 may include the method of example 8 and example 9 or some other example herein, wherein for DCI format 0_1/0_2 without scheduling PUSCH and without CSI Request, if aperiodic SRS is triggered, e.g. the SRS Request field is set to non-zero, some un-used DCI fields could be repurposed for beam indication, wherein the un-used DCI fields are the same as the un-used fields in the case of DCI format 0_1/0_2 without scheduling PUSCH, without CSI Request and without SRS triggered.

Example 12 may include the method of example 8 and example 9 or some other example herein, wherein for beam indication via DCI format 0_1/0_2 without scheduling PUSCH, without CSI Request and with aperiodic SRS triggered, the successful reception of the triggered aperiodic SRS at the gNB could serve as acknowledgement (ACK) to the beam indication. After receiving the ACK, the gNB side could begin to use the new TCI state for communication.

Example 13 may include the method of example 8 and example 9 or some other example herein, wherein in the scenario of carrier aggregation, multiple TCI states could be indicated via DCI format 0_1/0_2 without scheduling PUSCH, without CSI Request and with aperiodic SRS triggered, one TCI state for each component carrier (CC). Or one TCI state is indicated and is applied to multiple CCs. Or one TCI state is indicated, and a bitmap is used to indicate which CC can apply the TCI state.

Example 14 may include the method of example 8 and example 9 or some other example herein, wherein for beam indication via DCI format 0_1/0_2 without scheduling PUSCH, without CSI Request and with aperiodic SRS triggered, the indicated TCI state could be applied for the triggered aperiodic SRS transmission if the indicated TCI state is common DL/UL TCI or separate UL TCI state. In another example, if the time gap between the triggering DCI and the triggered SRS is smaller than certain threshold, wherein the threshold defines the beam application time for beam indication and the threshold could be pre-defined or up to UE capability, then the triggered SRS should utilize the previous beam for transmission instead of the indicated one. If the time gap between the triggering DCI and the triggered SRS is larger than or equal to certain threshold, then the indicated TCI state could be applied for the triggered aperiodic SRS transmission.

Example 15 may include the method of example 8 and example 9 or some other example herein, wherein if TCI state is indicated via DCI format 0_1/0_2 without scheduling PUSCH, without CSI Request and with aperiodic SRS triggered, an SR-like over PUCCH could serve as acknowledgement (ACK) to the beam indication. The dedicated SR-like PUCCH resource could be configured to the UE. After receiving the beam indication, the UE could send the SR-like PUCCH for several times, e.g. N times, where N could be configurable or predefined. After the gNB receives the SR-like PUCCH, the gNB assumes the UE has received the beam indication DCI. In another example, after receiving the beam indication, the UE could send the SR-like PUCCH for several times, e.g. N times. After the gNB receives the SR-like PUCCH, the gNB should send another DCI with UL grant, e.g. PUSCH resource allocation. After the UE receives the UL grant, the UE knows the ACK to beam indication has been received by the gNB.

Example 16 may include the method of example 8 and example 9 or some other example herein, wherein if TCI state is indicated via DCI format 0_1/0_2 without scheduling PUSCH, without CSI Request and with aperiodic SRS triggered, the UE should provide HARQ-ACK information in response to the beam indication DCI after N symbols from the last symbol of a PDCCH carrying the beam indication, wherein the value of N could be configurable or pre-defined.

Example 17 may include a method of a gNB, the method comprising: generating a downlink control information (DCI) for transmission to a user equipment (UE), wherein the DCI has a DCI format of 0_1 or 0_2 and includes an uplink scheduling (UL-SCH) indicator that indicates that a physical uplink shared channel (PUSCH) is not scheduled by the DCI; and indicating to the UE, using one or more bits in the DCI, a transmission configuration indicator (TCI) state.

Example 18 may include the method of example 17 or some other example herein, wherein the DCI does not request channel state information (CSI) from the UE (e.g., the DCI includes a CSI request field that indicates that no CSI is requested, such as all zeros).

Example 19 may include the method of example 17-18 or some other example herein, wherein the DCI does not trigger the UE to transmit a sounding reference signal (SRS) (e.g., the DCI includes a SRS request field that indicates that no SRS is triggered, such as all zeros).

Example 20 may include the method of example 17-19 or some other example herein, wherein the DCI triggers the UE to transmit a sounding reference signal (SRS) (e.g., the DCI includes a SRS request field that indicates that a SRS is triggered).

Example 21 may include the method of example 17-20 or some other example herein, wherein the TCI state is indicated using one or more bits of a modulation and coding scheme (MCS) field, a hybrid automatic repeat request (HARQ) field, and/or another field of the DCI.

Example 22 may include the method of example 17-21 or some other example herein, wherein the TCI state includes: a common downlink (DL)/uplink (UL) TCI state, separate DL and UL TCI states, a DL TCI state only (no UL TCI state), or a UL TCI state only (no DL TCI state).

Example 23 may include the method of example 20 or some other example herein, wherein the DCI includes an MCS field to configure one or more parameters for the SRS.

Example 24 may include the method of example 23 or some other example herein, wherein the TCI state is indicated by one or more bits of a HARQ field.

Example 25 may include a method of a UE, the method comprising: receiving a downlink control information (DCI) from a next generation Node B (gNB), wherein the DCI has a DCI format of 0_1 or 0_2 and includes an uplink scheduling (UL-SCH) indicator that indicates that a physical uplink shared channel (PUSCH) is not scheduled by the DCI; and decoding one or more bits of the DCI to determine a transmission configuration indicator (TCI) state.

Example 26 may include the method of example 25 or some other example herein, wherein the DCI does not request channel state information (CSI) from the UE (e.g., the DCI includes a CSI request field that indicates that no CSI is requested, such as all zeros).

Example 27 may include the method of example 25-26 or some other example herein, wherein the DCI does not trigger the UE to transmit a sounding reference signal (SRS) (e.g., the DCI includes a SRS request field that indicates that no SRS is triggered, such as all zeros).

Example 28 may include the method of example 25-26 or some other example herein, wherein the DCI triggers the UE to transmit a sounding reference signal (SRS) (e.g., the DCI includes a SRS request field that indicates that a SRS is triggered).

Example 29 may include the method of example 25-28 or some other example herein, wherein the TCI state is indicated using one or more bits of a modulation and coding scheme (MCS) field, a hybrid automatic repeat request (HARQ) field, and/or another field of the DCI.

Example 30 may include the method of example 25-29 or some other example herein, wherein the TCI state includes: a common downlink (DL)/uplink (UL) TCI state, separate DL and UL TCI states, a DL TCI state only (no UL TCI state), or a UL TCI state only (no DL TCI state).

Example 31 may include the method of example 28 or some other example herein, wherein the DCI includes an MCS field to configure one or more parameters for the SRS.

Example 32 may include the method of example 31 or some other example herein, wherein the TCI state is indicated by one or more bits of a HARQ field.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus for a user equipment (UE) configured for operation in a fifth-generation (5G) new radio (NR) (5G-NR) system, the apparatus comprising: processing circuitry; and memory,
the processing circuitry configured to:
decode a downlink control information (DCI) format, the DCI format comprising one of DCI format 0_1 and DCI format 0_2;
wherein when the DCI format does not schedule a physical uplink shared channel (PUSCH) and does not trigger a sounding reference signal (SRS) transmission, and when the DCI format triggers a channel state information (CSI) request including at least one of a CSI reference signal (CSI-RS) operation, a CSI interference measurement (CSI-IM), and a CSI report transmission, the processing circuitry is configured to:
interpret one or more fields of the DCI format for PUSCH scheduling and/or SRS triggering as indicating additional information for the triggered CSI request; and
perform the triggered CSI request using at least the information in the one or more fields of the DCI.

2. The apparatus of claim 1, wherein the processing circuitry is configured to decode the DCI format to:
determine that the DCI format does not schedule the PUSCH when an UL-SCH indicator is present and is set to zero;
determine that the DCI format does not trigger the SRS transmission when an SRS request field is set to all zeros; and
determine that the DCI format triggers the CSI request when a CSI request field is set to a non-zero value.

3. The apparatus of claim 2, wherein the triggered CSI request includes at least one of an aperiodic CSI-RS operation, an CSI-IM and an aperiodic CSI report transmission.

4. The apparatus of claim 3, wherein the one or more fields of the DCI format for PUSCH scheduling and/or SRS triggering include one or more of:
a modulation and coding scheme (MCS) field, a Hybrid automatic repeat request (HARQ) field, a redundancy version field, a new data indicator field, and a transmit power control (TPC) command for PUSCH field,
wherein the processing circuitry is to interpret the one or more fields to configure a resource allocation for the triggered CSI request.

5. The apparatus of claim 4, wherein the one or more fields to configure the resource allocation for the triggered CSI request comprise at least one of:
CSI-RS resource mapping, a bandwidth part (BWP) identifier (BWP-ID) indicating a BWP for reception of a CSI-RS, and power control offset information.

6. The apparatus of claim 5, wherein when the DCI format either schedules the PUSCH or the DCI format schedules the SRS transmission, the processing circuitry is configured to interpret the one or more fields of the DCI format for the PUSCH scheduling and/or the SRS triggering.

7. The apparatus of claim 6, wherein when the DCI format does not schedule a PUSCH, does not trigger an SRS transmission, and does not trigger a CSI request, the processing circuitry is configured to interpret one or more fields of the DCI format for beam indication.

8. The apparatus of claim 7, wherein when the UE is configured for multi-transmission-reception point (m-TRP) operation, and
wherein when the one or more fields are interpreted for beam indication, the one or more fields may be decoded by the processing circuitry as indicating first and second transmission control indication (TCI) states, the first TCI state associated with a first TRP, the second TCI state associated with a second TRP, and
the processing circuitry is configured to apply the first and second TCI states for reception of reference signals from the first and second TRPs.

9. The apparatus of claim 8, wherein the UE comprises a plurality of antennas configured by the processing circuitry for multi-beam operation.

10. The apparatus of claim 9, wherein the processing circuitry comprises baseband processor.

11. A non-transitory computer-readable storage medium that stores instructions for execution by processing circuitry of a user equipment (UE) configured for operation in a fifth-generation (5G) new radio (NR) (5G-NR) system, the instructions to configure the processing circuitry to:
decode a downlink control information (DCI) format, the DCI format comprising one of DCI format 0_1 and DCI format 0_2;
wherein when the DCI format does not schedule a physical uplink shared channel (PUSCH) and does not trigger a sounding reference signal (SRS) transmission, and when the DCI format triggers a channel state information (CSI) request including at least one of a CSI reference signal (CSI-RS) operation, a CSI interference measurement (CSI-IM), and a CSI report transmission, the processing circuitry is configured to:
interpret one or more fields of the DCI format for PUSCH scheduling and/or SRS triggering as indicating additional information for the triggered CSI request; and
perform the triggered CSI request using at least the information in the one or more fields of the DCI.

12. The non-transitory computer-readable storage medium of claim 11, wherein the processing circuitry is configured to decode the DCI format to:
determine that the DCI format does not schedule the PUSCH when an UL-SCH indicator is present and is set to zero;
determine that the DCI format does not trigger the SRS transmission when an SRS request field is set to all zeros; and
determine that the DCI format triggers the CSI request when a CSI request field is set to a non-zero value.

13. The non-transitory computer-readable storage medium of claim 12, wherein the triggered CSI request includes at least one of an aperiodic CSI-RS operation, an CSI-IM and an aperiodic CSI report transmission.

14. The non-transitory computer-readable storage medium of claim 13, wherein the one or more fields of the DCI format for PUSCH scheduling and/or SRS triggering include one or more of:
a modulation and coding scheme (MCS) field, a Hybrid automatic repeat request (HARQ) field, a redundancy version field, a new data indicator field, and a transmit power control (TPC) command for PUSCH field,
wherein the processing circuitry is to interpret the one or more fields to configure a resource allocation for the triggered CSI request.

15. The non-transitory computer-readable storage medium of claim 14, wherein the one or more fields to configure the resource allocation for the triggered CSI request comprise at least one of:
CSI-RS resource mapping, a bandwidth part (BWP) identifier (BWP-ID) indicating a BWP for reception of a CSI-RS, and power control offset information.

16. The non-transitory computer-readable storage medium of claim 15, wherein when the DCI format either schedules the PUSCH or the DCI format schedules the SRS transmission, the processing circuitry is configured to interpret the one or more fields of the DCI format for the PUSCH scheduling and/or the SRS triggering.

17. The non-transitory computer-readable storage medium of claim 17, wherein when the DCI format does not schedule a PUSCH, does not trigger an SRS transmission, and does not trigger a CSI request, the processing circuitry is configured to interpret one or more fields of the DCI format for beam indication.

18. The non-transitory computer-readable storage medium of claim 17, wherein when the UE is configured for multi-transmission-reception point (m-TRP) operation, and
wherein when the one or more fields are interpreted for beam indication, the one or more fields may be decoded by the processing circuitry as indicating first and second transmission control indication (TCI) states, the first TCI state associated with a first TRP, the second TCI state associated with a second TRP, and
the processing circuitry is configured to apply the first and second TCI states for reception of reference signals from the first and second TRPs.

19. An apparatus for gNodeB (gNB) configured for operation in a fifth-generation (5G) new radio (NR) (5G-NR) system, the apparatus comprising: processing circuitry; and memory,
the processing circuitry configured to:
encode a downlink control information (DCI) format for transmission to a user equipment (UE), the DCI format comprising one of DCI format 0_1 and DCI format 0_2;
wherein when the DCI format does not schedule a physical uplink shared channel (PUSCH) and does not trigger a sounding reference signal (SRS) transmission, and when the DCI format riggers a channel state information (CSI) request including at least one of a CSI reference signal (CSI-RS) operation, a CSI interference measurement (CSI-IM), and a CSI report transmission, the processing circuitry is configured to:
encode one or more fields of the DCI format for PUSCH scheduling and/or SRS triggering as indicating additional information for the triggered CSI request,
wherein the one or more fields of the DCI format for PUSCH scheduling and/or SRS triggering include one or more of a modulation and coding scheme (MCS) field, a Hybrid automatic repeat request (HARQ) field, a redundancy version field, a new data indicator field, and a transmit power control (TPC) command for PUSCH field,
wherein the processing circuitry is to encode the one or more fields to configure a resource allocation for the triggered CSI request, and
wherein the memory is configured to store the information in the one or more fields of the DCI.

20. The apparatus of claim 19, wherein the processing circuitry is configured to encode the DCI format to:
include an UL-SCH indicator in the DCI format and set the UL-SCH indicator to zero to indicate that the DCI format does not schedule the PUSCH;
set an SRS request field to all zeros to indicate that the DCI format does not trigger the SRS transmission; and
set a CSI request field to a non-zero value to indicate that the DCI format triggers the CSI request, and
wherein the one or more fields to configure the resource allocation for the triggered CSI request comprise at least one of: CSI-RS resource mapping, a bandwidth part (BWP) identifier (BWP-ID) indicating a BWP for reception of a CSI-RS, and power control offset information.
